(19) United States
(12) Patent Application Publication
(10) Pub. No.: US 2026/0350931 A1
(43) Pub. Date: Nov. 5, 2026

(54) VIRTUAL-REAL FUSION METHOD AND APPARATUS FOR MIXED REALITY, AND SYSTEM

(71) Applicant: GRAVITYXR ELECTRONICS AND TECHNOLOGY CO., LTD., Ningbo (CN)

(72) Inventors: Yi QIU, Ningbo (CN); Tao JIA, Ningbo (CN); Yicheng WANG, Ningbo (CN); Wen YIN, Ningbo (CN); Chaohao WANG, Ningbo (CN)

(21) Appl. No.: 19/488,527

(22) PCT Filed: Apr. 24, 2024
(86) PCT No.: PCT/CN2024/089588

§ 371 Date: Nov. 26, 2025

(30) Foreign Application Priority Data
May 30, 2023 (CN) 202310629358.X

(51) Int. Cl. G06T 19/00; G06T 3/4007; G06T 5/30; G06T 7/11; G06T 7/50; G06T 7/90

(52) U.S. Cl. CPC G06T 19/006; G06T 3/4007; G06T 5/30; G06T 7/11; G06T 7/50; G06T 7/90; G06T 2207/10024; G06T 2207/10028; G06T 2207/20028; G06T 2207/20036; G06T 2207/20072; G06T 2207/20192; G06T 2207/20221

(57) ABSTRACT

This application is directed to a virtual-real fusion method and apparatus for mixed reality, and a system and a medium, which relate to machine vision and image fusion. The method includes acquiring an RGB image and a depth image; acquiring a virtual image and a virtual depth; comparing the depth image with the virtual depth to generate an occlusion relationship graph, generating a color model of based on a historical frame of the RGB image and the occlusion relationship graph; performing edge-preserving filtering on the color model using the latest frame of the RGB image, so as to obtain a final fusion weight graph; and according to the final fusion weight graph, performing weighted fusion on an RGB image and the virtual image, to generate a display image Fusion parameters are determined using color modeling and edge-preserving filtering ensuring matching of a depth image and an RGB image, and reducing a display delay.

The present invention claims priority to the Chinese patent application No. 202310629358.X, filed May 30, 2023, entitled “A mixed reality virtual-real fusion method, apparatus, and system”.

### TECHNICAL FIELD

The present invention relates to the field of machine vision and image fusion technology, and in particular to a mixed reality virtual-real fusion method, apparatus, system, and medium.

### BACKGROUND

Mixed Reality (MR) technology presents virtual scene information within real-world scenes, establishing an interactive feedback loop of information between the real world, the virtual world, and the user, thereby enhancing the authenticity of the user experience.

Mixed reality systems have high requirements for the realistic display of virtual objects, aiming to seamlessly integrate virtual objects with real objects, maintaining the immersion of the scene and the realism of the virtual objects. These requirements also pose new challenges for display technology.

In existing mixed reality system architectures, virtual objects are rendered in virtual-real fusion scenes. To determine the front-to-back occlusion relationship between virtual objects and real objects during virtual-real combination, the following three display strategies are typically adopted:
1)Virtual objects are always displayed in front of real objects;
2)Attempting to obtain as accurate depth information as possible and directly comparing the depth of real objects and virtual objects;
3)Extracting certain information from the image of real objects and perform matting combined with incompletely accurate depth.

Regarding the first display strategy, the display effect is not realistic enough, resulting in a poor user experience.

Regarding the second display strategy, the computational load required for processing the depth image is very large, potentially making real-time calculation impossible. According to algorithms in the prior art, the average processing time is 48.4 ms, and the display delay is about 116 ms, meaning it can only support virtual-real fusion at a maximum of 20 FPS, with a delay that is noticeably perceptible to the human eye.

Regarding the third display strategy, according to algorithms in the prior art, it typically requires the depth image and the RGB image to be from the same moment. However, in wearable devices, limited by power consumption and heat generation, the delay in acquiring the depth image is usually much higher than that of acquiring the RGB image, and the frame rate is often lower than that of the RGB image. Therefore, it is difficult for the algorithm to use the latest RGB image, which similarly increases the overall delay of the display system. Based on the above analysis, the virtual-real fusion display effect in mixed reality systems in the prior art is poor, and the existing delay is difficult to effectively resolve.

### SUMMARY

The purpose of the present invention is to provide a mixed reality virtual-real fusion method, apparatus, system, and medium to solve the problems of poor display effects and significant delay in prior art virtual reality virtual-real fusion.

To achieve the above purpose, the present invention provides a mixed reality virtual-real fusion method, comprising the following steps:
acquiring an RGB image and a depth image of a real scene, and acquiring a virtual image and a virtual depth;
comparing the depth image with the virtual depth to generate an occlusion relationship map, and generating a color model on the basis of a historical frame of the RGB image and the occlusion relationship map;
performing edge-preserving filtering on the color model by using the latest frame of the RGB image, so as to obtain a final fusion weight map; and
according to the final fusion weight map, performing weighted fusion on the RGB image of the real scene and the virtual image, so as to mixedly generate a display image.

In some embodiments, wherein the comparing the depth image with the virtual depth to generate the occlusion relationship map, and generating the color model on the basis of the historical frame of the RGB image and the occlusion relationship map, further comprises:
selecting the latest frame of the depth image, a virtual depth from the historical frame of the virtual image, and the historical frame of the RGB image;
comparing the depth image and the virtual depth of the virtual image, and marking an occlusion relationship in the historical frame of the RGB image, so as to obtain a first occlusion relationship map;
selecting the historical frame of the RGB image, and performing blocking, and according to the first occlusion relationship map generating a color model for different occlusion regions of each block of image respectively.

In some embodiments, wherein the performing edge-preserving filtering on the color model by using the latest frame of the RGB image, so as to obtain the final fusion weight map, further comprises:
selecting the latest frame of the RGB image, and according to the color model of the historical frame of the RGB image estimating a probability that a pixel point is occluded, so as to obtain an occlusion probability map;
acquiring the latest frame of the RGB image, and performing edge-preserving filtering on the occlusion probability map, so as to obtain a first weight map; and
using the first weight map as the final fusion weight map.

In some embodiments, wherein the acquiring the latest frame of the RGB image, and performing edge-preserving filtering on the occlusion probability map, so as to obtain the first weight map, further comprises:
acquiring a luminance component of the latest frame of the RGB image, and performing guided filtering on the occlusion probability map by using the luminance component, so as to obtain the first weight map.

In some embodiments, wherein the acquiring the latest frame of the RGB image, and performing edge-preserving filtering on the occlusion probability map, so as to obtain the first weight map, further comprises:
acquiring the latest frame of the RGB image, and performing bilateral filtering on the occlusion probability map, so as to obtain the first weight map.

In some embodiments, wherein the method further comprises the following steps:
performing a morphological transformation on the first occlusion relationship map, so as to obtain a second weight map; and
performing weighted fusion on the first weight map and the second weight map, so as to obtain a third weight map, and using the third weight map as the final fusion weight map.

In some embodiments, wherein the acquiring the RGB image and the depth image of the real scene, further comprises: continuously acquiring the RGB image, the depth image, and an exposure timestamp of the real scene at a preset frame rate; and
wherein the acquiring the virtual image and the virtual depth, further comprises: continuously acquiring the virtual image and the virtual depth of the virtual image at the preset frame rate.

In some embodiments, wherein after the acquiring the RGB image and the depth image of the real scene, and acquiring the virtual image and the virtual depth, further comprises:
performing downsampling on all the acquired images to low-resolution images; and
before according to the final fusion weight map, performing weighted fusion on the RGB image of the real scene and the virtual image, so as to generate the display image by means of mixing, further comprises:
performing upsampling on the final fusion weight map to a display resolution.

In some embodiments, wherein for the acquired depth image and virtual depth, performing downsampling using nearest-neighbor interpolation.

In some embodiments, wherein the marking the occlusion relationship in the RGB image, further comprises:
dividing the RGB image into three parts comprising a region for displaying the virtual image, a region for displaying the real image, and a region to be determined;
marking the region for displaying the virtual image as a first coefficient;
marking the region for displaying the real image as a second coefficient; and
marking the region to be determined as a third coefficient.

In some embodiments, wherein the marking the occlusion relationship in the RGB image, further comprises:
marking a region where depth is missing as the region to be determined; and
not marking a region where virtual depth is missing.

In some embodiments, wherein the performing the morphological transformation on the first occlusion relationship map, so as to obtain the second weight map, further comprises:
performing morphological dilation on the region to be determined of the first occlusion relationship map, so as to obtain a second occlusion relationship map; and
performing edge processing on the second occlusion relationship map, so as to obtain the second weight map.

In some embodiments, wherein the performing edge processing on the second occlusion relationship map, so as to obtain the second weight map, further comprises:
performing filtering the second occlusion relationship map and performing trinarization processing, so as to obtain a third occlusion relationship map; and
performing filtering on the third occlusion relationship map, so as to obtain the second weight map.

In some embodiments, wherein the color model comprises a color histogram; and
the generating the color model for different occlusion regions of each block of image, further comprises:
performing color histogram statistics on an unoccluded region and an occluded region in each block of image respectively.

In some embodiments, wherein when performing color histogram statistics, a color depth is subjected to downsampling processing.

In some embodiments, wherein the selecting the latest frame of the RGB image, and according to the color model of the historical frame of the RGB image estimating the probability that the pixel point is occluded, so as to obtain the occlusion probability map, further comprises:
performing morphological dilation on the region to be determined of the first occlusion relationship map, so as to obtain a second occlusion relationship map; and
selecting the latest frame of the RGB image, and according to a position of the region to be determined in the second occlusion relationship map, estimating a probability that each pixel point in a corresponding region of the latest frame of the RGB image is occluded, so as to obtain the occlusion probability map.

In some embodiments, wherein the according to a position of the region to be determined in the second occlusion relationship map, estimating a probability that each pixel point in a corresponding region of the latest frame of the RGB image is occluded, so as to obtain the occlusion probability map, further comprises:
selecting several block images from the historical frame of the RGB image that are closest to a current pixel point;
according to color models of the several block images, estimating a color model of a region close to the current pixel point;
according to the estimated color model, calculating a distribution of a color of the current pixel point in different occlusion regions;
according to the distribution, estimating a probability that the current pixel point is occluded; and
performing regularization constraint on a probability value, so as to obtain the occlusion probability map.

In some embodiments, wherein the luminance component, further comprises a Y channel in a YUV space, an L channel in a Lab space, an I channel in an HSI space, and an L channel in an HSL space.

To achieve the above purpose, the present invention provides a mixed reality virtual-real fusion apparatus, comprises an image information processor, a depth information processor, a central processor, and a display processing unit, wherein:
the image information processor, connected to the central processor and the display processing unit, and configured to acquire an RGB image of a real scene and send the RGB image to the central processor and the display processing unit;
the depth information processor, connected to the central processor, and configured to acquire a depth image of the real scene and send the depth image to the central processor;
the central processor, connected to the display processing unit, and configured to acquire a virtual depth, the steps of any one of the mixed reality virtual-real fusion method are executed, and send a final fusion weight map to the display processing unit; and
the display processing unit, configured to acquire the final fusion weight map sent by the central processor, and perform weighted fusion on the RGB image of the real scene and the virtual image, so as to generate a display image by means of mixing.

In an embodiment, wherein the image information processor is connected to a scene camera, and acquires collection data of the scene camera and generates the RGB image; and
the depth information processor is connected to a depth sensor, and acquires collection data of the depth sensor and generates the depth image.

To achieve the above purpose, the present invention provides a mixed reality virtual-real fusion system, wherein the system comprises a mixed reality virtual-real fusion apparatus, a scene camera, a depth sensor, a graphics processor, and a display device:
the mixed reality virtual-real fusion apparatus, adopting the mixed reality virtual-real fusion apparatus of any one of the above;
the scene camera, configured to collect an RGB image of a real scene and send the RGB image to the mixed reality virtual-real fusion apparatus;
the depth sensor, configured to collect a depth image of the real scene and send the depth image to the mixed reality virtual-real fusion apparatus;
the graphics processor, configured to generate a virtual image and a virtual depth and send the virtual image and the virtual depth to the mixed reality virtual-real fusion apparatus; and
the display device, configured to receive a display image generated by the mixed reality virtual-real fusion apparatus and display the display image.

To achieve the above purpose, the present invention provides a computer-readable medium, storing computer instructions stored thereon, wherein when the computer instructions are executed by a processor, the method of any one of the above is executed.

The present invention provides a mixed reality virtual-real fusion method, apparatus, system, and medium, it uses color modeling and edge-preserving filtering to calculate image fusion parameters, taking into account both historical and current RGB images to ensure accurate matching between depth images and RGB images, it is also able to use the latest image information to effectively reduce display delay.

### BRIEF DESCRIPTION OF THE DRAWINGS

The above and other features, characteristics, and advantages of the present invention will become more apparent from the following description in conjunction with the drawings and embodiments. In the drawings, the same reference numerals consistently denote the same features, wherein:

FIG. 1 shows a flow diagram of a mixed reality virtual-real fusion method according to an embodiment of the present invention;

FIG. 2 shows a flow diagram of the mixed reality virtual-real fusion method based on a color model and guided filtering according to a first embodiment of the present invention;

FIG. 3 shows a schematic diagram of image blocking according to an embodiment of the present invention;

FIG. 4 shows a flow diagram of the mixed reality virtual-real fusion method based on a color model and guided filtering according to a second embodiment of the present invention;

FIG. 5 shows a workflow diagram of the mixed reality virtual-real fusion algorithm based on a color model and guided filtering according to a second embodiment of the present invention;

FIG. 6 shows an algorithm module diagram of the mixed reality virtual-real fusion apparatus according to an embodiment of the present invention;

FIG. 7 shows a hardware schematic diagram of the mixed reality virtual-real fusion apparatus according to an embodiment of the present invention.

The meanings of the symbols marked in the figure are as follows:
610 image information processor;
620 depth information processor;
630 central processor;
640 display processing unit;
650 scene camera;
660 depth sensor;
670 graphics processor.

### DETAILED DESCRIPTION

In order to make the objectives, technical solutions, and advantages of the present invention clearer, the following further describes the present invention in detail with reference to the accompanying drawings and embodiments. It should be understood that the specific embodiments described herein are only used to explain the invention and are not intended to limit the invention.

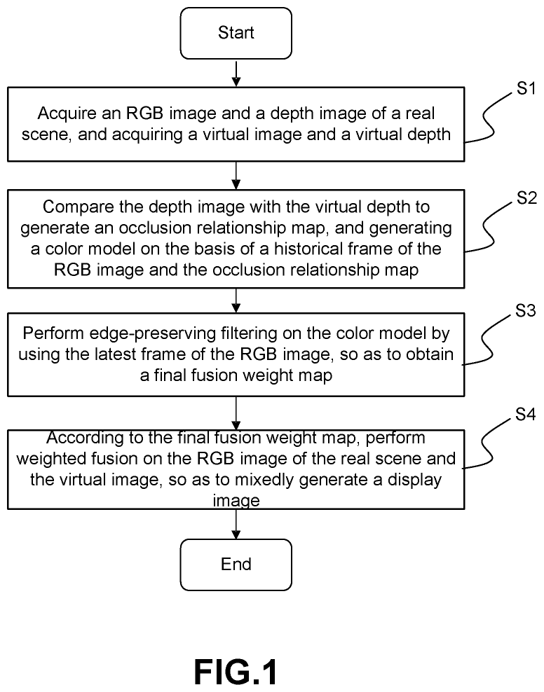

FIG. 1 shows a flow diagram of a mixed reality virtual-real fusion method according to an embodiment of the present invention, as shown in FIG. 1, the present invention provides the mixed reality virtual-real fusion method, comprising the following steps:
S1: acquiring an RGB image and a depth image of a real scene, and acquiring a virtual image and a virtual depth;
S2: comparing the depth image with the virtual depth to generate an occlusion relationship map, and generating a color model on the basis of a historical frame of the RGB image and the occlusion relationship map;
S3: performing edge-preserving filtering on the color model by using the latest frame of the RGB image, so as to obtain a final fusion weight map; and
S4: according to the final fusion weight map, performing weighted fusion on the RGB image of the real scene and the virtual image, so as to mixedly generate a display image.

Further, the S2, the comparing the depth image with the virtual depth to generate the occlusion relationship map, and generating the color model on the basis of the historical frame of the RGB image and the occlusion relationship map, further comprises:
selecting the latest frame of the depth image, a virtual depth from the historical frame of the virtual image, and the historical frame of the RGB image;
comparing the depth image and the virtual depth of the virtual image, and marking an occlusion relationship in the historical frame of the RGB image, so as to obtain a first occlusion relationship map;
selecting the historical frame of the RGB image, and performing blocking, and according to the first occlusion relationship map generating a color model for different occlusion regions of each block of image respectively.

Further, the S3, the performing edge-preserving filtering on the color model by using the latest frame of the RGB image, so as to obtain the final fusion weight map, further comprises:
selecting the latest frame of the RGB image, and according to the color model of the historical frame of the RGB image, estimating a probability that a pixel point is occluded, so as to obtain an occlusion probability map;
acquiring the latest frame of the RGB image, and performing edge-preserving filtering on the occlusion probability map, so as to obtain a first weight map; and
using the first weight map as the final fusion weight map.

The edge-preserving filtering method is to realize filtering using an edge-preserving filter. An edge-preserving filter refers to a special type of filter that can effectively preserve edge information in an image during the filtering process.

Among them, a bilateral filter, a guided image filter, and a weighted least square filter are several relatively well-known edge-preserving filters.

The following uses the edge-preserving filter as being the guided filter to illustrate the mixed reality virtual-real fusion method proposed by the present invention. It should be noted that using other edge-preserving filters can also implement the mixed reality virtual-real fusion method proposed by the present invention.

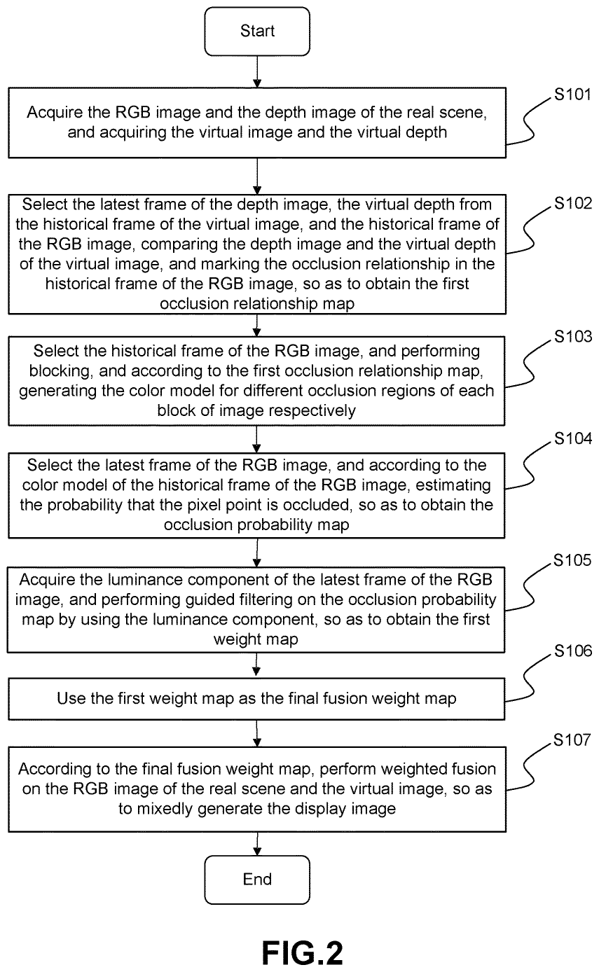

FIG. 2 shows a flow diagram of the mixed reality virtual-real fusion method based on a color model and guided filtering according to a first embodiment of the present invention. As shown in the first embodiment of FIG. 2, the mixed reality virtual-real fusion method based on the color model and the guided filtering proposed by the present invention, specifically comprises the following steps:
S101: acquiring the RGB image and the depth image of the real scene, and acquiring the virtual image and the virtual depth;
S102: selecting the latest frame of the depth image, the virtual depth of the historical frame of the virtual image, and the historical frame of the RGB image, comparing the depth image and the virtual depth of the virtual image, and marking the occlusion relationship in the historical frame of the RGB image, so as to obtain the first occlusion relationship map;
S103: selecting the historical frame of the RGB image, and performing blocking, and according to the first occlusion relationship map, generating the color model for different occlusion regions of each block of image respectively;
S104: selecting the latest frame of the RGB image, and according to the color model of the historical frame of the RGB image, estimating the probability that the pixel point is occluded, so as to obtain the occlusion probability map;
S105: acquiring the luminance component of the latest frame of the RGB image, and performing guided filtering on the occlusion probability map by using the luminance component, so as to obtain the first weight map;
S106: using the first weight map as the final fusion weight map;
S107: according to the final fusion weight map, performing weighted fusion on the RGB image of the real scene and the virtual image, so as to mixedly generate the display image.

The following describes these steps in detail. It should be understood that within the scope of the present invention, all the above technical features of the present invention and the respective technical features described specifically below (such as in the embodiments) can be combined with each other and correlated with each other to form preferred technical solutions.

S101: acquiring the RGB image and the depth image of the real scene, and acquiring the virtual image and the virtual depth.

Depth information refers to the distance of objects in the real scene from the camera. The shooting plane of the camera can be used as the X and Y axes of a three-dimensional coordinate system, then depth represents the Z-axis distance. Therefore, depth information can be used to determine occlusion relationships.

In some embodiments, continuously acquiring the RGB image, the depth image of the real scene, and the corresponding exposure timestamp at the preset frame rate. Preferably, the preset frame rate is a fixed frame rate. In other embodiments, the preset frame rate is allowed to have a time delay within a certain range but must not exceed a delay threshold.

In some embodiments, continuously acquiring the virtual image and the virtual depth (Z-buffer) of the virtual image at the preset frame rate. Preferably, the preset frame rate is a fixed frame rate. In other embodiments, the preset frame rate is allowed to have a time delay within a certain range but must not exceed a delay threshold.

In this embodiment, the virtual image and the virtual depth are continuously acquired from a graphics processor. The virtual image refers to the rendered image provided by the graphics processor.

Optionally, after acquiring all the images (RGB image, depth image, virtual image, and virtual depth), performing downsampling on all the acquired images to low-resolution images, to meet computational capability requirements and ensure the subsequent operational efficiency.

Clearly, the “low” resolution here is a relative concept relative to computational capability. When the images are downsampled to a resolution that meets computational capability requirements, it can be considered a low resolution.

Downsampling methods include but are not limited to bilinear interpolation and nearest-neighbor interpolation methods.

Preferably, for the acquired RGB image and virtual image, performing downsampling using bilinear interpolation;

Preferably, for the acquired depth image and virtual depth, performing downsampling using nearest-neighbor interpolation.

S102: selecting the latest frame of the depth image, the virtual depth from the historical frame of the virtual image, and the historical frame of the RGB image, comparing the depth image and the virtual depth of the virtual image, and marking the occlusion relationship in the historical frame of the RGB image, so as to obtain the first occlusion relationship map.

In this embodiment, the historical frame of the virtual image further refers to a historical frame in the virtual image whose exposure time is closest to the exposure time of the latest frame of the depth image.

In this embodiment, the historical frame of the RGB image further refers to a historical frame in the RGB image whose exposure time is closest to the exposure time of the latest frame of the depth image, denoted as the first RGB image.

Obviously, the exposure time can be determined through the exposure timestamp acquired in S101.

In this embodiment, the first occlusion relationship map is a first three-part map.

The first three-part map divides the image into three parts comprising a region for displaying the virtual image, a region for displaying the real image, and a region to be determined:
wherein, the region for displaying the virtual image, i.e., the virtual image-unoccluded region, is marked as a first coefficient; in this embodiment, the first coefficient is 0;
the region for displaying the real image, i.e., the virtual image-occluded region, is marked as a second coefficient; in this embodiment, the second coefficient is 1; and
the region to be determined, i.e., a region where it is temporarily undetermined whether to display the virtual image or the real image, is marked as a third coefficient; in this embodiment, the third coefficient is 0.5.

Further, a region where depth is missing is marked as the region to be determined;

Further, a region where virtual depth is missing is not marked.

S103: selecting the historical frame of the RGB image, and performing blocking, and according to the first occlusion relationship map, generating the color model for different occlusion regions of each block of image respectively.

In this embodiment, selecting the historical frame of the RGB image, and performing blocking, further comprises:
according to the exposure timestamp, selecting a frame of RGB image whose exposure time is closest to the exposure time of the latest frame of the depth image, which is the first RGB image, and dividing the first RGB image into several non-overlapping blocks.

Further, the first RGB image is divided into several non-overlapping blocks. The specific division method is not highly limited. The following lists two division methods as preferred implementation methods, but it should not be considered that the division method proposed by the present invention is limited to the following two:

For example, the entire image can be divided into a fixed number of rectangular blocks, such as 8 blocks each in the horizontal and vertical directions, totaling 8*8=64 blocks, with no overlap between the blocks.

For example, the entire image can be divided into fixed-size rectangular blocks, such as 32-pixel×32-pixel blocks, with no overlap between the blocks.

In other embodiments, the image blocking method can also divide the image into irregular-shaped blocks or mutually overlapping blocks in some way.

In this embodiment, the color model is a color histogram. The generating a color model for different occlusion regions of each block of image respectively, further comprises: performing color histogram statistics on an unoccluded region and an occluded region in each block of image respectively.

The color histogram, as a relatively common method, mainly describing the quantitative characteristics of color in the image, can reflect the statistical distribution of image color and the basic tone, and its function is to generate color statistical information for estimating the occlusion probability map, indicating the frequency of occurrence of various colors in a certain region of the image.

In other embodiments, the color model can also use other alternative means, such as a Gaussian Mixture Model (GMM).

Further, when performing color histogram statistics, performing downsampling processing on a color depth. Optionally, the color depth can be downsampled to 4-bit color or lower.

S104: selecting the latest frame of the RGB image, and according to the color model of the historical frame of the RGB image, estimating the probability that the pixel point is occluded, so as to obtain the occlusion probability map.

The S104 further comprises the following steps:
performing the morphological transformation on the region to be determined of the first occlusion relationship map, so as to obtain the second occlusion relationship map;
selecting the latest frame of the RGB image, and according to a position of the region to be determined in the second occlusion relationship map, estimating the probability that each pixel point in the corresponding region of the latest frame of the RGB image is occluded, so as to obtain the occlusion probability map.

In this embodiment, the second occlusion relationship map is a second three-part map. Morphological dilation is performed on the region to be determined of the first three-part map, so as to obtain the second three-part map.

Morphological dilation refers to expanding the boundary points of a binarized object, merging all background points in contact with the object into the object, causing the boundary to expand outward.

Morphological dilation is generally divided into horizontal dilation, vertical dilation, and omnidirectional dilation.

In this embodiment, using a 3*3 rectangular kernel for morphological dilation.

The latest frame of the RGB image is selected, and denoted as the second RGB image. Clearly, in this embodiment, the latest frame refers to the latest exposure time.

According to the position of the region to be determined marked in the second three-part map, estimating a probability that each pixel point in the corresponding region of the second RGB image is occluded, so as to obtain the occlusion probability map, specifically comprising the following steps:
in the historical frame of the RGB image of S103, selecting several block images that are closest to the current pixel point;
according to the color models of the several block images, estimating a color model of a region close to the current pixel point;
according to the estimated color model, calculating a distribution of a color of the current pixel point in different occlusion regions;
according to the distribution, estimating a probability that the current pixel point is occluded;
performing regularization constraint on the probability value, so as to obtain the occlusion probability map.

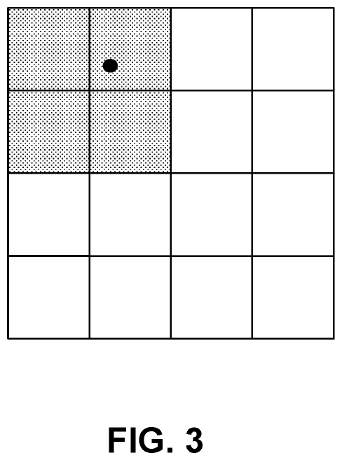

FIG. 3 shows a schematic diagram of image blocking by an embodiment of the present invention. As shown in FIG. 3, in this embodiment, the image is divided into mutually non-overlapping rectangular blocks. Selecting the 4 block images closest to the current pixel point, according to the color histograms statistics of these 4 block images, estimating the color histogram near the current pixel point. According to the estimated color histogram, calculating the distribution of the color of the current pixel point in different occlusion regions.

The method for determining the 4 block images closest to the current pixel point is: the 4 block images with the smallest Euclidean distance between the geometric center and the pixel position.

For all rectangular grid and non-overlapping blocking methods, the nearest 4 block images are clearly a preferred embodiment. As shown in FIG. 3, the color histograms of the four gray blocks are used when calculating the probability value of the pixel point represented by the dot.

In other embodiments, using more blocks is also allowed, for example, using 16 blocks.

Due to other possible blocking methods, modifying the definitions of “closest” and “most close” is allowed, such as the several blocks closest in the vertical or horizontal direction, the several blocks with the smallest weighted distance, etc. Therefore, the representation range of “closest” and “most close” is not limited to the method of “minimum Euclidean distance”.

In this embodiment, calculating the distribution of the current pixel point in different occlusion regions, and according to the distribution estimating a probability that the current pixel point is occluded, further comprises:
using the color histogram, respectively calculating the frequency of occurrence of the color of the current pixel point in the regions marked 0 and 1 in the nearby four rectangular blocks;
and weighting these frequencies according to the distance from the geometric center of the block to the “current pixel point”;
summing the frequency of occurrence in the 0 region and the frequency of occurrence in the 1 region, to obtain a sum value;
dividing the frequency of occurrence in the 1 region by the obtained sum value, and using the ratio as the probability that the current pixel point is occluded.

Regularization is adding constraints to the minimized empirical error function, and such constraints can be interpreted as prior knowledge.

S105: acquiring the luminance component of the latest frame of the RGB image, and performing guided filtering on the occlusion probability map by using the luminance component, so as to obtain the first weight map.

The luminance component, further comprises but is not limited to a Y channel in a YUV space, an L channel in a Lab space, an I channel in an HSI space, and an L channel in an HSL space.

YUV is a color encoding method, where Y represents luma. Lab color space is a color-opponent space, with dimension L representing lightness. HSI refers to a model of a digital image, where brightness I corresponds to imaging brightness and image grayscale, and is the brightness of the color. HSL is a representation of points in the RGB color model in a cylindrical coordinate system, where L is lightness.

In this embodiment, the latest frame of the RGB image, denoted as the second RGB image, is converted to a color space containing a luminance component, and the luminance channel therein is taken as a guide map to perform guided filtering on the occlusion probability map, so as to obtain the first weight map.

Guided filtering is used to transfer information from the RGB image to the three-part map, generating fusion weights.

Guided filtering, i.e., guided image filtering, is an image filtering technique. Through a guide map G, filtering processing is performed on a target image P (input image), so that the final output image is generally similar to the target image P, but the texture part is similar to the guide map G.

As an edge-preserving filter, guided filtering has been widely used in image dehazing technology and matting technology in recent years. Compared with the bilateral filter, guided filtering can obtain comparable filtering effects in edge preservation and detail smoothing, and its advantages are more reflected in computing speed and filtering efficiency, because its core process can be realized quickly by summation operations within a window when an integral image is known. Therefore, the algorithm has high efficiency and low complexity. Its edge-preserving capability precisely meets the requirements when optimizing depth maps, and at the same time the real-time performance of high-efficiency computation also makes it more competitive in practice.

S106: using the first weight map as the final fusion weight map.

The parameters of the final fusion weight map serve as image virtual-real fusion parameters.

S107: according to the final fusion weight map, performing weighted fusion on the RGB image of the real scene and the virtual image, so as to mixedly generate the display image.

Further, in the display pipeline, guided filtering can be used again to upsample the final fusion weight map to a display resolution, and mix the RGB image and the virtual image into the display image.

The mixed reality virtual-real fusion method based on a color model and guided filtering proposed in the first embodiment of the present invention acquires the initial three-part map and color modeling information from historical RGB images, ensuring depth matching, then reconstructs the color modeling information into a new three-part map in the latest RGB image, ensuring that the final effect acts on the latest image and reducing delay.

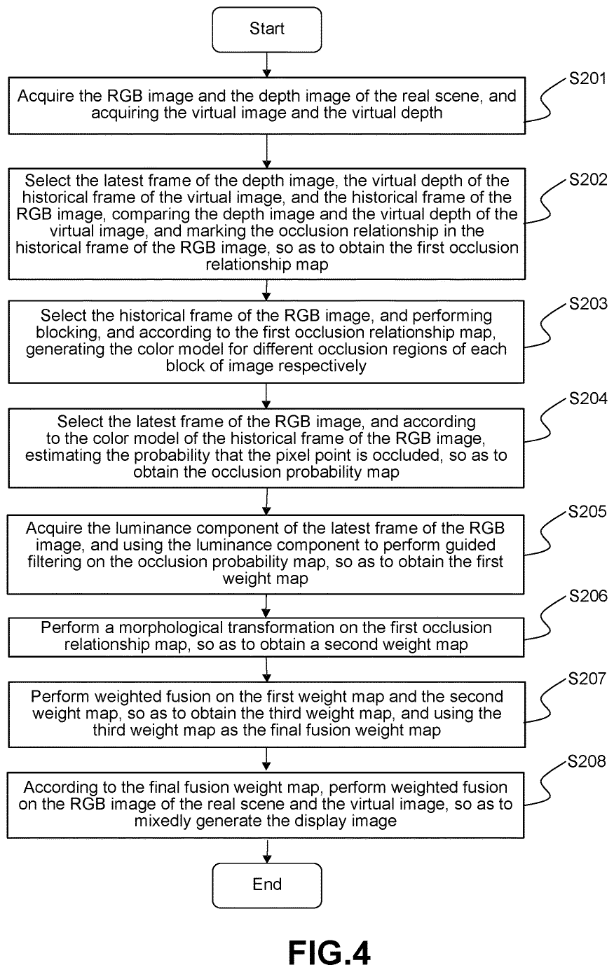

FIG. 4 shows a flow diagram of the mixed reality virtual-real fusion method based on a color model and guided filtering according to a second embodiment of the present invention. As shown in the second embodiment of FIG. 4, the mixed reality virtual-real fusion method based on the color model and guided filtering proposed by the present invention specifically comprises the following steps:
S201: acquiring the RGB image and the depth image of the real scene, and acquiring the virtual image and the virtual depth;
S202: selecting the latest frame of the depth image, the virtual depth from the historical frame of the virtual image, and the historical frame of the RGB image, comparing the depth image and the virtual depth of the virtual image, and marking the occlusion relationship in the historical frame of the RGB image, so as to obtain the first occlusion relationship map;
S203: selecting the historical frame of the RGB image, and performing blocking, and according to the first occlusion relationship map, generating the color model for different occlusion regions of each block of image respectively;
S204: selecting the latest frame of the RGB image, and according to the color model of the historical frame of the RGB image, estimating the probability that the pixel point is occluded, so as to obtain the occlusion probability map;
S205: acquiring the luminance component of the latest frame of the RGB image, and using the luminance component to perform guided filtering on the occlusion probability map, so as to obtain the first weight map;
S206: performing a morphological transformation on the first occlusion relationship map, so as to obtain a second weight map;
S207: performing weighted fusion on the first weight map and the second weight map, so as to obtain the third weight map, and using the third weight map as the final fusion weight map;
S208: according to the final fusion weight map, performing weighted fusion on the RGB image of the real scene and the virtual image, so as to mixedly generate the display image.

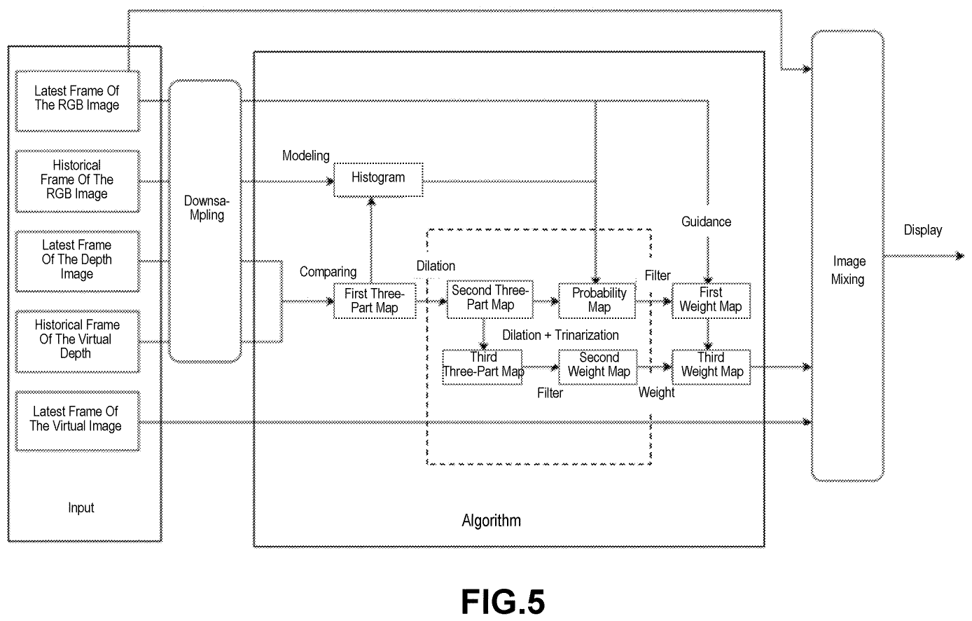

FIG. 5 shows a workflow diagram of the mixed reality virtual-real fusion algorithm based on a color model and guided filtering according to a second embodiment of the present invention. As shown in FIG. 4 and FIG. 5, in the second embodiment and the first embodiment, S201-S205 are the same as S101-S105, and S208 is the same as S107. The difference lies in S206 and S207, i.e., the dashed line part in FIG. 4.

The following describes S206 and S207 in detail.

The S206 further comprises:
performing morphological dilation on the region to be determined of the first occlusion relationship map, so as to obtain a second occlusion relationship map;
performing edge processing on the second occlusion relationship map, so as to obtain the second weight map.

Further, the performing edge processing on the second occlusion relationship map, so as to obtain the second weight map, further comprises:
performing filtering on the second occlusion relationship map and performing trinarization processing, so as to obtain a third occlusion relationship map;
performing filtering on the third occlusion relationship map, so as to obtain the second weight map.

In this embodiment, the first occlusion relationship map is the first three-part map, the second occlusion relationship map is the second three-part map, and the third occlusion relationship map is the third three-part map.

In this embodiment, the performing filtering on the second three-part map and performing trinarization processing, further comprises:
performing mean filtering on the second three-part map, and then performing trinarization processing using the third coefficient as a threshold;
wherein, the third coefficient is 0.5.

In this embodiment, the trinarization processing method is:
for values greater than the third coefficient after filtering, setting them to the second coefficient; for values less than the third coefficient after filtering, setting them to the first coefficient; for values equal to the third coefficient after filtering, setting them to the third coefficient;
wherein, the first coefficient is 0, the second coefficient is 1, and the third coefficient is 0.5

In this embodiment, the performing filtering on the third three-part map, further comprises:
performing mean filtering on the third three-part map.

It should be noted that in this embodiment, mean filtering is performed on both the second three-part map and the third three-part map. In other embodiments, different filters can also be used for the second three-part map and the third three-part map. Other low-pass image filters can be used, such as Gaussian filtering or bilateral filtering with precisely designed thresholds.

S207: performing weighted fusion on the first weight map and the second weight map, so as to obtain a third weight map, and using the third weight map as the final fusion weight map.

The first weight map and the second weight map are weighted fused according to a certain calculation rule to obtain the third weight map, and the third weight map is output as the final virtual-real fusion weight.

The calculation rule for weighted fusion can be fusion through confidence. The confidence can be generated according to the value of the first weight map, or can be an externally generated confidence, such as depth confidence.

S208: according to the final fusion weight map, performing weighted fusion on the RGB image of the real scene and the virtual image, so as to mixedly generate the display image.

Further, in the display pipeline, guided filtering can be used again to upsample the third weight map to a display resolution, and mix the RGB image and the virtual image into a display image.

In the first embodiment, the first weight map is used as the final fusion weight map. The first weight map is related to the depth image, but the depth image has lower precision and higher delay compared to the RGB image, and can only obtain blurred edges and details. The second weight map is related to the RGB image content and can obtain precise edges and details.

Compared with the first embodiment, the second embodiment uses a multi-weight joint calculation method, performing weighted fusion of the second weight map and the first weight map, ensuring that edge transitions are not abrupt.

For example, in some cases, it is necessary to display the user's hand in the virtual scene, i.e., the scene seen by the user includes one's own hand (from the RGB image), and the rest is the virtual scene (from the virtual image). Suppose due to light, coloring, etc., one finger of the hand in the RGB image has a significantly different color from the other fingers and palm.

In the first embodiment, when only the first weight map is used, due to the precision issue of the depth image, the gaps between the user's fingers may not be accurately identified, and the user can see objects from the RGB image between the fingers;

The second embodiment fuses two weights, and the resulting output effect is like “the user can clearly see their normally colored fingers and palm, the display effect at the finger gaps is completely normal, and they can also see their own finger with the different color, but the edge of this finger is relatively blurred”. This effect is more in line with general human perception than using either the first weight map or the second weight map alone. Therefore, the fusion effect of the second embodiment is better than that of the first embodiment.

Although the methods are illustrated and described as a series of acts for simplicity of explanation, it should be understood and appreciated that these methods are not limited by the order of acts, as some acts may, in accordance with one or more embodiments, occur in different orders and/or concurrently with other acts from that shown and described herein, or not shown and described herein, but understood by those skilled in the art.

To achieve the above mixed reality virtual-real fusion method, the present invention also provides a mixed reality virtual-real fusion apparatus, which can be in the form of a chip architecture or other hardware/software forms.

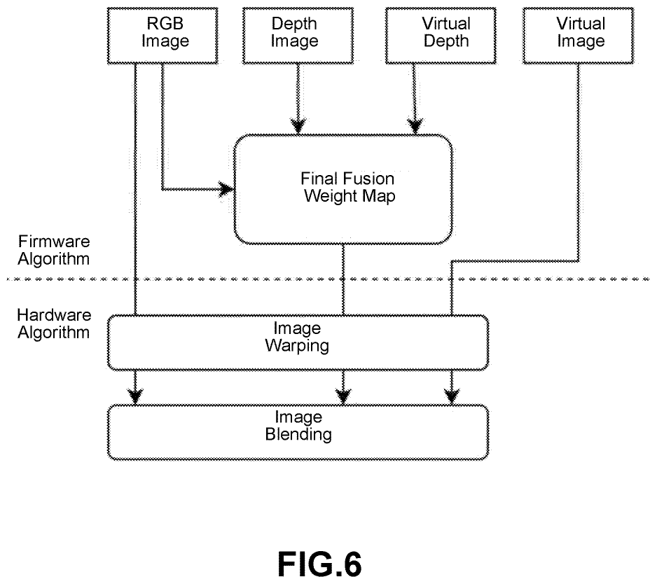

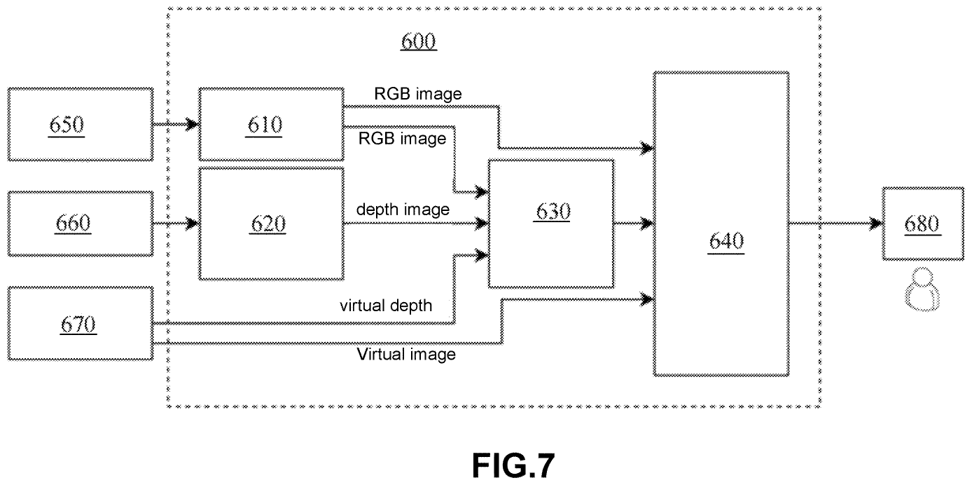

FIG. 6 shows an algorithm module diagram of the mixed reality virtual-real fusion apparatus by an embodiment of the present invention. FIG. 7 shows a hardware schematic diagram of the mixed reality virtual-real fusion apparatus by an embodiment of the present invention. As shown in FIG. 6 and FIG. 7, the mixed reality virtual-real fusion apparatus 600 proposed by the present invention comprises an image information processor 610, a depth information processor 620, a central processor 630, and a display processing unit 640:
the image information processor 610, connected to the central processor 630 and the display processing unit 640, and configured to acquire an RGB image of a real scene and send the RGB image to the central processor 630 and the display processing unit 640;
the depth information processor 620, connected to the central processor 630, and configured to acquire a depth image of the real scene and send the depth image to the central processor 630;
the central processor 630, connected to the display processing unit 640, and configured to acquire a virtual depth, and according to the acquired RGB image, depth image of the real scene, and the virtual depth, execute the mixed reality virtual-real fusion method, and send a final fusion weight map to the display processing unit 640;
the display processing unit 640, configured to acquire the final fusion weight map sent by the central processor 630, and perform weighted fusion on the RGB image of the real scene and the virtual image, so as to mixedly generate a display image.

In this embodiment, the image information processor 610 is an AISC ISP chip, connected to a scene camera 650, and configured to acquire collection data of the scene camera 650 and generate the RGB image.

In this embodiment, the depth information processor 620 is an NPU or other computing unit capable of running depth calculation algorithms, connected to a depth sensor 660, and configured to acquire collection data of the depth sensor 660 and generate the depth image.

In this embodiment, the central processor 630 is a CPU or other computing unit capable of running the mixed reality virtual-real fusion method.

As shown in FIG. 6 and FIG. 7, the display processing unit 640 performs fusion to generate the display image through image warping and image blending. Image warping causes the input image to deform, so that pixels corresponding to the same object are located at the same position. Image blending combines the input various information into the final picture that the user ultimately watches through the display device 680.

In this embodiment, the display processing unit 640 is an AISC display processing unit;
the display processing unit 640 is connected to a graphics processor (GPU) 670, and configured to acquire rendered image (virtual image) data from the GPU;
the display processing unit 640 is connected to the image information processor 610, and configured to acquire the RGB image from the image information processor;
the display processing unit 640 is connected to the central processor 630, and configured to acquire the final fusion weight from the central processor 630;
the display processing unit 640 is connected to a display device 680, and configured to output the mixedly generated display image to the display device 680.

In this embodiment, the display device 680 can be a head-mounted display or glasses, etc.

When the implementation process file of the mixed reality virtual-real fusion method is a computer program, it can also be stored in a computer-readable storage medium as a product. For example, the computer-readable storage medium can include but is not limited to magnetic storage devices (e.g., hard disk, floppy disk, magnetic strip), optical disks (e.g., compact disk (CD), digital versatile disk (DVD)), smart cards, and flash memory devices (e.g., erasable programmable read-only memory (EPROM), card, stick, key drive). Furthermore, the various storage media described herein can represent one or more devices and/or other machine-readable media for storing information. The term “machine-readable medium” can include but is not limited to wireless channels and various other media (and/or storage media) that can store, contain, and/or carry code and/or instructions and/or data.

The present invention provides a mixed reality virtual-real fusion method, apparatus, and medium, which use a color modeling and edge-preserving filtering method to calculate image virtual-real fusion parameters, considering both historical and current RGB images to ensure correct matching between depth images and RGB images, and also able to utilize the latest image information to effectively reduce display delay.

As shown in this specification and the claims, unless the context clearly indicates an exception, the words “a”, “an”, and/or “the” are not intended to refer solely to the singular form, but may also include the plural form. Generally, the terms “comprise” and “include” only indicate the inclusion of clearly identified steps and elements, and these steps and elements do not constitute an exclusive list; the method or device may also contain other steps or elements.

Those skilled in the art will understand that information, signals, and data may be represented using any of a variety of different technologies and techniques. For example, data, instructions, commands, information, signals, bits, symbols, and chips referenced throughout the above description may be represented by voltages, currents, electromagnetic waves, magnetic fields or magnetic particles, optical fields or optical particles, or any combination thereof.

Those skilled in the art will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the described functions may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Any connection is also properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

The foregoing embodiments are provided for those skilled in the art to implement or use the present invention. Those skilled in the art can make various modifications or changes to the foregoing embodiments without departing from the inventive concept of the present invention. Therefore, the protection scope of the present invention is not limited by the foregoing embodiments, but should be the maximum scope consistent with the innovative features mentioned in the claims.

1. A mixed reality virtual-real fusion method, comprising:
acquiring an RGB image and a depth image of a real scene, and acquiring a virtual image and a virtual depth;
comparing the depth image with the virtual depth to generate an occlusion relationship map, and generating a color model on a basis of a historical frame of the RGB image and the occlusion relationship map;
performing edge-preserving filtering on the color model by using the latest frame of the RGB image, so as to obtain a final fusion weight map; and
according to the final fusion weight map, performing weighted fusion on the RGB image of the real scene and the virtual image, so as to mixedly generate a display image.

2. The mixed reality virtual-real fusion method of claim 1, wherein the comparing the depth image with the virtual depth to generate the occlusion relationship map, and generating the color model on the basis of the historical frame of the RGB image and the occlusion relationship map, further comprises:
selecting the latest frame of the depth image, a virtual depth of a historical frame of the virtual image, and the historical frame of the RGB image;
comparing the depth image and the virtual depth of the virtual image, and marking an occlusion relationship in the historical frame of the RGB image, so as to obtain a first occlusion relationship map;
selecting the historical frame of the RGB image, and performing blocking, and according to the first occlusion relationship map, generating the color model for different occlusion regions of each block of image respectively.

3. The mixed reality virtual-real fusion method of claim 1, wherein the performing edge-preserving filtering on the color model by using the latest frame of the RGB image, so as to obtain the final fusion weight map, further comprises:
selecting the latest frame of the RGB image, and according to the color model of the historical frame of the RGB image, estimating a probability that a pixel point is occluded, so as to obtain an occlusion probability map;
acquiring the latest frame of the RGB image, and performing edge-preserving filtering on the occlusion probability map, so as to obtain a first weight map; and
using the first weight map as the final fusion weight map.

4. The mixed reality virtual-real fusion method of claim 3, wherein the acquiring the latest frame of the RGB image, and performing edge-preserving filtering on the occlusion probability map, so as to obtain the first weight map, further comprises:
acquiring a luminance component of the latest frame of the RGB image, and performing guided filtering on the occlusion probability map by using the luminance component, so as to obtain the first weight map;
wherein the luminance component, further comprises a Y channel in a YUV space, an L channel in a Lab space, an I channel in an HSI space, and an L channel in an HSL space.

5. The mixed reality virtual-real fusion method of claim 3, wherein the acquiring the latest frame of the RGB image, and performing edge-preserving filtering on the occlusion probability map, so as to obtain the first weight map, further comprises:
acquiring the latest frame of the RGB image, and performing bilateral filtering on the occlusion probability map, so as to obtain the first weight map.

6. The mixed reality virtual-real fusion method of claim 2, further comprising:
performing a morphological transformation on the first occlusion relationship map, so as to obtain a second weight map; and
performing weighted fusion on the first weight map and the second weight map, so as to obtain a third weight map as the final fusion weight map.

7. The mixed reality virtual-real fusion method of claim 1, wherein the acquiring the RGB image and the depth image of the real scene, further comprises: continuously acquiring the RGB image, the depth image, and an exposure timestamp of the real scene at a preset frame rate; and
wherein the acquiring the virtual image and the virtual depth, further comprises: continuously acquiring the virtual image and the virtual depth of the virtual image at a preset frame rate.

8. The mixed reality virtual-real fusion method of claim 1, wherein after the acquiring the RGB image and the depth image of the real scene, and acquiring the virtual image and the virtual depth, further comprises:
performing downsampling on all the acquired images to low-resolution images; and
before according to the final fusion weight map, performing weighted fusion on the RGB image of the real scene and the virtual image, so as to generate the display image by means of mixing, further comprises:
performing upsampling on the final fusion weight map to a display resolution.

9. The mixed reality virtual-real fusion method of claim 8, wherein for the acquired RGB image and virtual image, performing downsampling using bilinear interpolation.

10. The mixed reality virtual-real fusion method of claim 8, wherein for the acquired depth image and virtual depth, performing downsampling using nearest-neighbor interpolation.

11. The mixed reality virtual-real fusion method of claim 2, wherein the marking the occlusion relationship in the RGB image, further comprises:
dividing the RGB image into three parts comprising a region for displaying the virtual image, a region for displaying the real image, and a region to be determined;
marking the region for displaying the virtual image as a first coefficient;
marking the region for displaying the real image as a second coefficient; and
marking the region to be determined as a third coefficient.

12. The mixed reality virtual-real fusion method of claim 11, wherein the marking the occlusion relationship in the RGB image, further comprises:
marking a region where depth is missing as the region to be determined; and
not marking a region where virtual depth is missing.

13. The mixed reality virtual-real fusion method of claim 6, wherein the performing the morphological transformation on the first occlusion relationship map, so as to obtain the second weight map, further comprises:
performing morphological dilation on a region to be determined of the first occlusion relationship map, so as to obtain a second occlusion relationship map; and
performing edge processing on the second occlusion relationship map, so as to obtain the second weight map.

14. The mixed reality virtual-real fusion method of claim 13, wherein the performing edge processing on the second occlusion relationship map, so as to obtain the second weight map, further comprises:
performing filtering the second occlusion relationship map and performing trinarization processing, so as to obtain a third occlusion relationship map; and
performing filtering on the third occlusion relationship map, so as to obtain the second weight map.

15. The mixed reality virtual-real fusion method of claim 2, wherein the color model comprises a color histogram; and
the generating the color model for different occlusion regions of each block of image, further comprises:
performing color histogram statistics on an unoccluded region and an occluded region in each block of image respectively.

16. The mixed reality virtual-real fusion method of claim 15, wherein when performing color histogram statistics, a color depth is subjected to downsampling processing.

17. The mixed reality virtual-real fusion method of claim 3, wherein the selecting the latest frame of the RGB image, and according to the color model of the historical frame of the RGB image, estimating the probability that the pixel point is occluded, so as to obtain the occlusion probability map, further comprises:
performing morphological dilation on the region to be determined of the first occlusion relationship map, so as to obtain a second occlusion relationship map; and
selecting the latest frame of the RGB image, and according to a position of the region to be determined in the second occlusion relationship map, estimating a probability that each pixel point in a corresponding region of the latest frame of the RGB image is occluded, so as to obtain the occlusion probability map.

18. The mixed reality virtual-real fusion method of claim 13, wherein the according to a position of the region to be determined in the second occlusion relationship map, estimating a probability that each pixel point in a corresponding region of the latest frame of the RGB image is occluded, so as to obtain the occlusion probability map, further comprises:
selecting several block images from the historical frame of the RGB image that are closest to a current pixel point;
according to color models of the several block images, estimating a color model of a region close to the current pixel point;
according to the estimated color model, calculating a distribution of a color of the current pixel point in different occlusion regions;
according to the distribution, estimating a probability that the current pixel point is occluded; and
performing regularization constraint on a probability value, so as to obtain the occlusion probability map.

19. (canceled)

20. (canceled)

21. (canceled)

22. (canceled)

23. A non-transitory computer-readable storage medium, having instructions stored thereon, which when executed by one or more processors cause the processors to perform operations comprising,
acquiring an RGB image and a depth image of a real scene, and acquiring a virtual image and a virtual depth;
comparing the depth image with the virtual depth to generate an occlusion relationship map, and generating a color model on a basis of a historical frame of the RGB image and the occlusion relationship map;
performing edge-preserving filtering on the color model by using the latest frame of the RGB image, so as to obtain a final fusion weight map; and
according to the final fusion weight map, performing weighted fusion on the RGB image of the real scene and the virtual image, so as to mixedly generate a display image.

24. A computing machine, comprising:
one or more processors;
memory having instructions stored thereon, which when executed by the one or more processors cause the processors to perform operations, comprising:
acquiring an RGB image and a depth image of a real scene, and acquiring a virtual image and a virtual depth;
comparing the depth image with the virtual depth to generate an occlusion relationship map, and generating a color model on a basis of a historical frame of the RGB image and the occlusion relationship map;
performing edge-preserving filtering on the color model by using the latest frame of the RGB image, so as to obtain a final fusion weight map; and
according to the final fusion weight map, performing weighted fusion on the RGB image of the real scene and the virtual image, so as to mixedly generate a display image.
